(19) United States
(12) Patent Application Publication
(10) Pub. No.: US 2008/0143660 A1
(43) Pub. Date: Jun. 19, 2008

(54) Display device

(76) Inventor: Shigeru Itou, Mobara (JP)

Correspondence Address: REED SMITH LLP, Suite 1400, 3110 Fairview Park Drive, Falls Church, VA, 22042, US

(21) Appl. No.: 12/000,509

(22) Filed: Dec. 13, 2007

(30) Foreign Application Priority Data
Dec. 15, 2006 (JP) 2006-338711

(51) Int. Cl. G09G 3/36

(52) U.S. Cl. 345/87

(57) ABSTRACT

The present invention provides a display device which can reduce the number of parts by incorporating a display control circuit in a video line drive circuit. In a display device which includes a display panel having a plurality of pixels and a plurality of video lines which inputs a video voltage to the plurality of pixels, and a plurality of video line drive circuits which supplies a video voltage to the plurality of video lines, each video line drive circuit includes a display control circuit, and one video line drive circuit out of the plurality of video line drive circuits is operable as a master video line drive circuit, and the video line drive circuits other than the master video line drive circuit out of the plurality of video line drive circuits are operable as slave video line drive circuits.

### CLAIM OF PRIORITY

The present application claims priority from Japanese application serial No. 2007-117844, filed on Apr. 27, 2007, the content of which is hereby incorporated by reference into this application.

### BACKGROUND OF THE INVENTION

1. Field of the Invention

The present invention relates to a display device, and more particularly to a liquid crystal display device having a video line drive circuit (also referred to as a drain driver or a source driver) which incorporates a display control circuit (also referred to as a timing controller).

2. Description of Related Arts

A TFT-type liquid crystal display module which uses a thin film transistor as an active element, since the module can display a high-definition image, has been used as a display device such as a television receiver set or a personal computer display. Particularly, a miniaturized TFT-type liquid crystal display device has been popularly used as a display part of a mobile phone.

In general, with respect to this liquid crystal display module, in a region which is surrounded by two neighboring scanning lines (also referred to as gate lines) and two neighboring video lines (also referred to as source lines or drain lines), a thin film transistor which is turned on in response to a scanning signal from the scanning line and a pixel electrode to which a video signal from the video line is supplied via the thin film transistor are formed thus constituting a so-called sub pixel.

A display region is a region in which the plurality of sub pixels is formed, and a peripheral region surrounds the display region. On the peripheral region, a drain driver (also referred to as a source driver) which supplies a video voltage (gray scale voltage) to the respective video lines and a gate driver which supplies a scanning voltage to the respective scanning lines are mounted.

A display control signal is inputted to the drain driver and the gate driver from a display control circuit (also referred to as a timing controller) such that the drain driver and the gate driver are controlled and driven by the display control circuit.

### SUMMARY OF THE INVENTION

In general, the drain driver is arranged on one side (long side) of a liquid crystal display panel, and the gate driver is arranged on another side (short side) of the liquid crystal display panel. Here, the drain driver and the gate driver are mounted on a glass substrate by a COG method and is mounted on another printed circuit board, for example. For example, the display control circuit is mounted on a back side of the liquid crystal display module.

On the other hand, although there has been a demand for the reduction of cost of the liquid crystal display module conventionally, recently there arises a demand for the further reduction of the cost of the liquid crystal display module. As one of techniques for achieving the reduction of cost of the liquid crystal display module, the reduction of the number of parts is named.

The present invention has been made to overcome the above-mentioned drawbacks of the related art, and it is an object of the present invention to provide a display device which can reduce the number of parts by incorporating a display control circuit in the inside of a video line drive circuit.

The above-mentioned and other objects and the novel features of the present invention will become apparent from the description of this specification and attached drawings.

To briefly explain the summary of typical inventions among inventions disclosed in this specification, they are as follows.

(1) In a display device which includes a display panel having a plurality of pixels and a plurality of video lines which inputs a video voltage to the plurality of pixels; and a plurality of video line drive circuits which supplies a video voltage to the plurality of video lines, each video line drive circuit includes a display control circuit, each video line drive circuit is connected to a bus, one video line drive circuit out of the plurality of video line drive circuit is operable as a master video line drive circuit, and the video line drive circuits other than the master video line drive circuit out of the plurality of video line drive circuits are operable as slave video line drive circuits.

(2) The present invention is, in the constitution (1), also characterized in that each video line drive circuit is operable as the master video line drive circuit when a voltage level of a voltage inputted to a master/slave change over terminal (MST) assumes a first voltage level, and is operable as the slave video line drive circuit when a voltage level of a voltage inputted to the master/slave changeover terminal (MST) is a second voltage level which differs from the first voltage level.

(3) The present invention is, in the constitution (1) or (2), also characterized in that the master video line drive circuit includes a clock oscillation circuit, and a clock from the clock oscillation circuit of the master video line drive circuit is inputted to the slave video line drive circuits.

(4) The present invention is, in the constitution (1) or (3), also characterized in that the plurality of video line drive circuits is arranged in series on a first side of the display panel, and a leading video line drive circuit out of the plurality of video line drive circuits which is arranged in series constitutes the master video line drive circuit and the next and succeeding video line drive circuits constitute the slave video line drive circuits.

(5) The present invention is, in any one of the constitutions (1) to (4), also characterized in that the display panel includes a plurality of scanning lines which inputs a scanning voltage to the plurality of pixels, the display panel includes at least one scanning line drive circuit which supplies the scanning voltage to the plurality of scanning lines, each video line drive circuit includes a plurality of scanning control terminals which outputs a scanning line drive circuit control signal for controlling at least one scanning line drive circuit, and the master video line drive circuit outputs the scanning line drive circuit control signal to at least one scanning line drive circuit from the plurality of scanning control terminals.

(6) The present invention is, in the constitution (5), also characterized in that the plurality of scanning control terminals is arranged on both left and right sides of each video line drive circuit in the longitudinal direction, and each video line drive circuit outputs the scanning line drive circuit control signal to at least one scanning line drive circuit from the plurality of scanning control terminals arranged on the left side when a voltage level of a voltage inputted to a scanning control terminal selection terminal (GLR) assumes a first voltage level, and outputs the scanning line drive circuit control signal to at least one scanning line drive circuit from the plurality of scanning control terminals arranged on the right side when the voltage level of the voltage inputted to the scanning control terminal selection terminal (GLR) assumes a second voltage level which differs from the first voltage level.

(7) The present invention is, in the constitution (5) or (6), also characterized in that at least one scanning line drive circuit is arranged on a second side of the display panel arranged close to a first side of the display panel.

(8) The present invention is, in any one of the constitutions (1) to (7), also characterized in that the display control circuit of each video line drive circuit includes a register for holding a predetermined value of the display control circuit, and the predetermined value of the display control circuit is writable to the register from an external memory when the display device is started.

(9) The present invention is, in the constitution (8), also characterized in that at the time of writing the predetermined value of the display control circuit from the external memory to the register at the time of starting the display device, the display device accesses to the external memory from the master video line drive circuit to the final slave video line drive circuits in order, and writes the predetermined value in the register.

To briefly explain advantageous effects acquired by the typical inventions among the inventions disclosed in this specification, they are as follows.

According to the display device of the present invention, by incorporating the display control circuit in the video line drive circuit, the number of parts can be reduced.

### BRIEF DESCRIPTION OF THE DRAWINGS

FIG. 1 is a block diagram showing the schematic constitution of a liquid crystal display module of an embodiment of the present invention;

FIG. 2 is a block diagram showing the schematic internal constitution of a drain driver shown in FIG. 1;

FIG. 3 is a view showing an arrangement example of the drain driver of the embodiment of the present invention;

FIG. 4 is a view showing another arrangement example of the drain driver of the embodiment of the present invention;

FIG. 5 is a view showing another arrangement example of the drain driver of the embodiment of the present invention;

FIG. 6 is a view showing another arrangement example of the drain driver of the embodiment of the present invention; and

FIG. 7 is a block diagram showing the schematic constitution of a conventional liquid crystal display module.

### DESCRIPTION OF THE PREFERRED EMBODIMENTS

Hereinafter, an embodiment in which the present invention is applied to a liquid crystal display module is explained in detail in conjunction with drawings.

Here, in all drawings for explaining the embodiment, parts having the identical functions are given same numerals and their repeated explanation is omitted.

### [Constitution of Conventional Liquid Crystal Display Module]

Firstly, a conventional liquid crystal display module is explained simply.

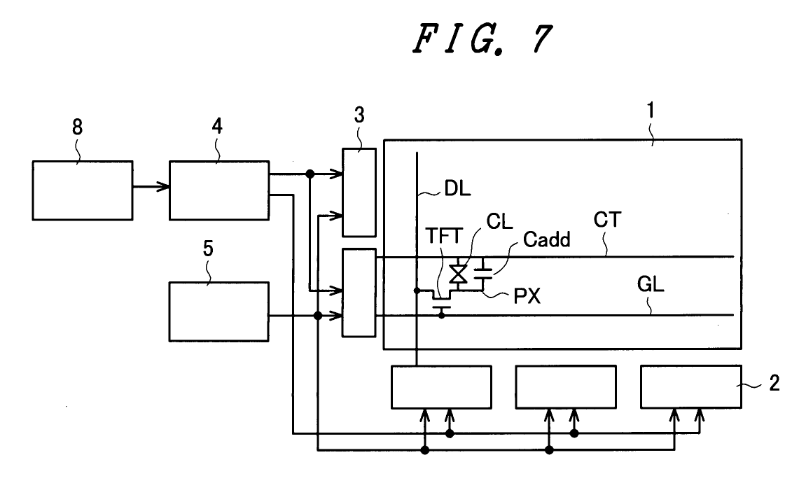

FIG. 7 is a block diagram showing the schematic constitution of the conventional liquid crystal display module.

The liquid crystal display module shown in FIG. 7 is constituted of a liquid crystal display panel 1, a drain driver 2, a gate driver 3, a display control circuit 4 and a power source circuit 5.

The drain driver 2 and the gate driver 3 are arranged on a peripheral portion of the liquid crystal display panel 1. For example, the drain driver 2 and the gate driver 3 are respectively mounted by a COG method on two peripheral portions of a first substrate (for example, a glass substrate) of a pair of substrates of the liquid crystal display panel 1. Alternatively, the drain driver 2 and the gate driver 3 are respectively mounted by a COF method on flexible printed circuit boards which are arranged on two peripheral portions of the first substrate of the liquid crystal display panel 1.

Further, the display control circuit 4 and the power source circuit 5 are respectively mounted on a printed circuit board arranged on the peripheral portion (for example, a back side of the liquid crystal display module) of the liquid crystal display panel 1.

The display control circuit 4 converts a display signal to be inputted from a graphic processor unit (GPU) 8 into display data of a display format by performing the timing adjustment suitable for display on the liquid crystal display panel 1 such as the alternation of data, and inputs the display data to the drain driver 2 and the gate driver 3 together with a synchronizing signal (a clock signal).

The gate driver 3 sequentially supplies a selective scanning voltage to scanning lines (also referred to as gate lines; GL) based on a control by the display control circuit 4, and the drain driver 2 supplies a video voltage to video lines (also referred to as drain lines or source lines; DL) so as to display an image. A power source circuit 5 generates various voltages necessary for the liquid crystal display device.

The liquid crystal display panel 1 includes a plurality of sub pixels and each sub pixel is formed in a region surrounded by the video lines (DL) and the scanning lines (GL).

Each sub pixel includes a thin film transistor (TFT), a first electrode (drain electrode or source electrode) of the thin film transistor (TFT) is connected to the video line (DL), and a second electrode (source electrode or drain electrode) of the thin film transistor (TFT) is connected to the pixel electrode (PX). Further, a gate electrode of the thin film transistor (TFT) is connected to the scanning line (GL).

Here, in FIG. 7, symbol CL indicates a liquid crystal capacitance which equivalently expresses a liquid crystal layer arranged between the pixel electrode (PX) and a counter electrode (CT). Symbol Cadd indicates a holding capacitance formed between the pixel electrode (PX) and the counter electrode (CT).

In the liquid crystal display panel 1 shown in FIG. 7, the first electrodes of the thin film transistors (TFT) of the respective sub pixels arranged in the column direction are connected to the respective video lines (DL), and the respective video lines (DL) are connected to the drain driver 2 which supplies a video voltage corresponding to display data to the sub pixels arranged in the column direction.

Further, the gate electrodes of the thin film transistors (TFT) of the respective sub pixels arranged in the row direction are connected to the respective scanning lines (G), and the respective scanning lines (G) are connected to the gate driver 3 which supplies a scanning voltage (positive or negative bias voltage) to the gates of the thin film transistors (TFT) for 1 horizontal scanning time.

In displaying an image on the liquid crystal display panel 1, the gate driver 3 sequentially selects the scanning lines (GL) from top to bottom, for example, while during a selection period of one scanning line, the drain driver 2 supplies a video voltage corresponding to display data to the video lines (DL). A voltage supplied to the video line (DL) is applied to the pixel electrodes (PX) via the thin film transistors (TFT) and, eventually, a charge is charged to a holding capacitance (Cadd) and a liquid crystal capacitance (CL) so that liquid crystal molecules are controlled thus displaying an image.

The liquid crystal display panel 1 is configured such that the first substrate which forms the pixel electrodes (PX), the thin film transistors (TFT) and the like thereon and the second substrate which forms color filters and the like thereon overlap each other with a predetermined gap therebetween, both substrates are laminated to each other by a sealing material formed in a frame shape in the vicinity of peripheral portions of both substrates, and liquid crystal is filled and sealed in a space defined between both substrates and the sealing material from a liquid crystal filling port formed in a portion of the sealing material. Further, polarizers are laminated to the outsides of both substrates.

Here, the counter electrode (CT) are formed on the second substrate side in case of a TN-type or VA-type liquid crystal display panel, while the counter electrode (CT) are formed on the first substrate side in case of an IPS-type liquid crystal display panel.

Further, the present invention is not relevant to the internal structure of the liquid crystal display panel and hence, the detailed explanation of the internal structure of the liquid crystal display panel is omitted. Further, the present invention is applicable to a liquid crystal display panel having any structure.

### EMBODIMENT

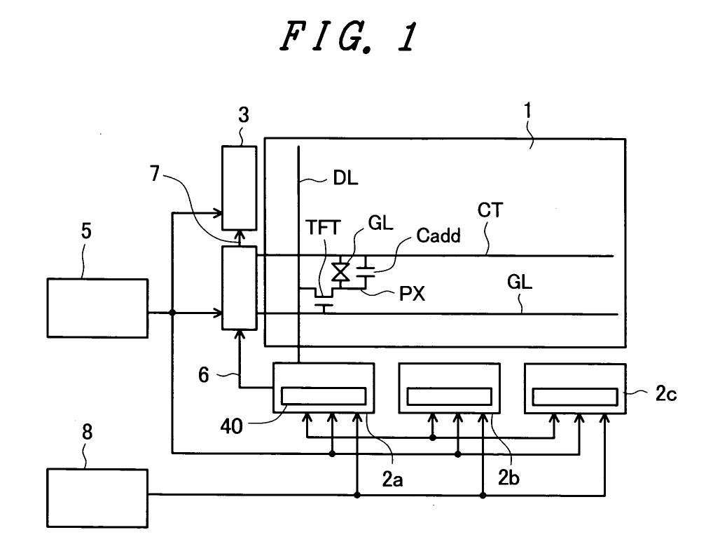

FIG. 1 is a block diagram showing the schematic constitution of a liquid crystal display module of an embodiment of the present invention.

In FIG. 1, numeral 40 indicates a display control circuit, and the liquid crystal display module of this embodiment is characterized in that a display control circuit 4 shown in FIG. 7 is incorporated into respective drain drivers (video line drive circuits of the present invention).

When the display control circuit 40 is incorporated into respective drain drivers (2a to 2c) as in the case of this embodiment, it is necessary to synchronize the respective display control circuits 40 incorporated into the respective drain drivers (2a to 2c). In this embodiment, among a plurality of drain drivers, one drain driver is operated as a master drain driver (drain driver indicated by symbol 2a in FIG. 1) and remaining other drain drivers are operated as slave drain drivers (drain driver indicated by symbols 2b, 2c in FIG. 1).

The master drain driver 2a generates a free-running clock, and the free-running clock generated by the master drain driver 2a is inputted to the slave drain drivers (2b, 2c). Due to such an operation, the master drain driver 2a is operable in synchronism with the slave drain drivers (2b, 2c).

Further, a gate driver control signal 6 is inputted from the master drain driver 2a to a leading gate driver 3 and, in response to a gate driver data transfer signal 7, a gate driver control signal is transferred to the next-stage gate driver 3 from the leading gate driver 3.

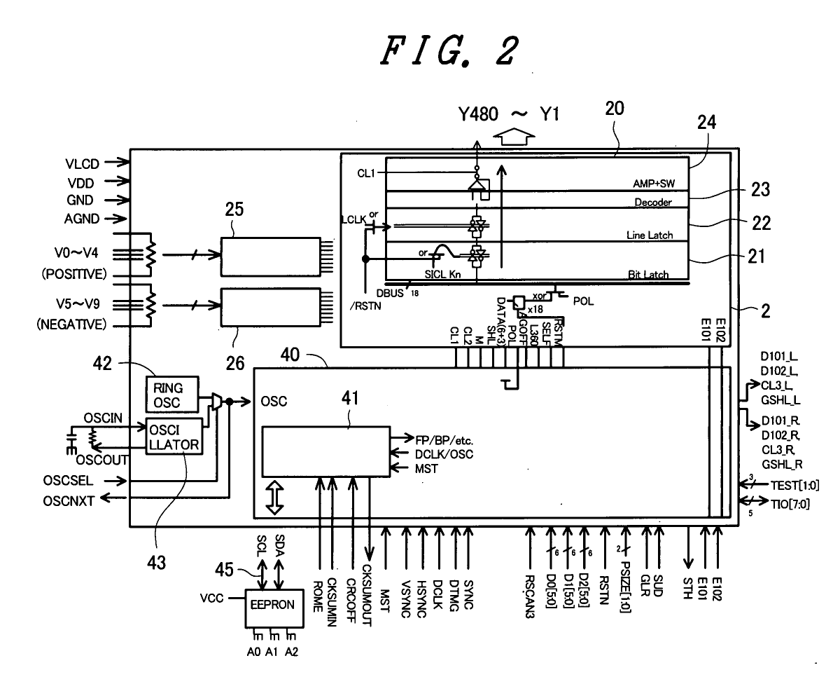

FIG. 2 is a block diagram showing the schematic internal constitution of the drain driver (2a to 2c) shown in FIG. 1. In FIG. 2, numeral 20 indicates a video line drive part and numeral 40 indicates a display control circuit.

The video line drive part 20 is constituted of a bit latch circuit 21, a line latch circuit 22, a decoder circuit 23, and an amplifier/switching circuit 24.

The bit latch circuit 21 sequentially latches display data inputted from the outside in synchronism with a display data latch clock (CL2) outputted from the display control circuit 40.

The line latch circuit 22 latches display data latched to the bit latch circuit 21 based on an output timing control clock signal (CL1) outputted from the display control circuit 40 and outputs the display data to the decoder circuit 23. Gray scale voltages of 64 gray scales of positive polarity and negative polarity, for example, are inputted to the decoder circuit 23. The decoder circuit 23 selects gray scale voltages corresponding to display data inputted from the line latch circuit 22 and input the gray scale voltages to the amplifier/switching circuit 24.

The amplifier/switching circuit 24 amplifies the gray scale voltages inputted from the decoder circuit 23 by the amplifier, and outputs the amplified voltages to the corresponding video lines (Y1 to Y480).

A gray scale reference voltage of positive polarity of V0 to V4 and a gray scale reference voltage of negative polarity of V5 to V9 are inputted to the drain drivers (2a to 2c).

A gray scale voltage generating circuit 25 of positive polarity generates gray scale reference voltages of positive polarity of 64 gray scales based on the gray scale reference voltage of positive polarity (V0 to V4), for example, and inputs the gray scale reference voltages to the decoder circuit 23. Further, a gray scale voltage generating circuit 26 of negative polarity generates gray scale reference voltages of negative polarity of 64 gray scales based on the gray scale reference voltage of negative polarity (V5 to V9), for example, and inputs the gray scale reference voltages to the decoder circuit 23.

The display control circuit 40 includes the register 41 in the inside thereof, and allows the register 41 to read predetermined values (for example, a drive method, polarity of VHSYNC/HSYNC, vertical effective number, horizontal effective number, a vertical blank period margin and the like) of the display control circuit 40 from an EEPROM 45 which constitutes an external memory at the time of starting the display device.

Further, the drain driver (2a to 2c) include an oscillation circuit 43 having an externally-mounted resistance (R) and a capacitor (C) and an internal ring oscillator 42.

Here, in FIG. 2, symbol VLCD-AGND indicates a voltage for driving liquid crystal, and symbol VDD-GND indicates a power source voltage for logic circuit.

Hereinafter, the drain drivers (2a to 2c) of this embodiment are explained along with the explanation of the terminals shown in FIG. 2.

To an OSCSEL terminal shown in FIG. 2, as a free-running clock, a signal which selects either one of an output of the oscillation circuit 43 having the externally-mounted resistance (R) and the capacitor (C) and an output of the internal ring oscillator 42 is inputted.

When the signal inputted to the OSCSEL terminal assumes a voltage of Low level (hereinafter referred to as L level) (GND in this embodiment), the output of the oscillation circuit 43 having the externally-mounted resistance (R) and the capacitor (C) is used as the free-running clock, while when the signal inputted to the OSCSEL terminal assumes a voltage of High level (hereinafter referred to as H level) (VDD in this embodiment), the output of the internal ring oscillator 42 is used as the free-running clock.

To an OSCIN terminal of the master drain driver 2a, the externally-mounted resistance (R) or the L level is connected in conformity with a use mode shown in the following Table 1.

Further, OSCIN terminals of the slave drain drivers (2b, 2c) are connected to the OSCNXT terminal of the master drain driver 2a, and the slave drain drivers (2b, 2c) use a clock which the master drain driver 2 a outputs as a free-running clock.

TABLE 1

| | | connection | | |
|---|---|---|---|---|
| MST | OSCSEL | destination | function | OSCNXT |
| 0 | 0 | connected to | CR self- | output |
| | | externally- | oscillation | self- |
| | | mounted | | oscillation |
| | | resistance R | | clock |
| 0 | 1 | connected to | use internal | |
| | | GND | ring oscillator | |
| 1 | * | connected to | input clock from | |
| | | OSCNXT terminal | master drain | |
| | | of master | driver | |
| | | drain driver | | |

A master/slave changeover signal is inputted to an MST terminal shown in FIG. 2. The drain driver is operated as the master drain driver when a voltage of L level is inputted to the MST terminal and is operated as the slave drain driver when a voltage of H level is inputted to the MST terminal.

To an LOC terminal, a signal for recognizing the final drain driver out of the drain drivers connected in cascade connection is inputted. The signal inputted to the LOC terminal is mainly used for setting an EIO output terminal of a final stage to high impedance (hereinafter, referred to as Hi-Z).

When a voltage of H level is inputted to the LOC terminal, the drain driver recognizes that the drain driver is the final drain driver.

A vertical synchronizing signal is inputted to a VSYNC terminal, a horizontal synchronizing signal is inputted to an HSYNC terminal, and a display timing signal (horizontal display data enable) is inputted to a DTMG terminal.

A data transfer clock is inputted to the DCLK terminal, and display data is acquired at a falling edge of the data transfer clock.

A signal for selecting a drive method is inputted to an SYNC terminal, and drive methods shown in the following Table 2 are adopted in response to signals inputted to the SYNC terminal.

Here, values of the drive methods (EXSY) can be set in an EEPROM 45 which constitutes an external memory. A default value of the drive method (EXSY) is “0”.

TABLE 2

| EXSY | SYNC | drive method |
|---|---|---|
| 0 | 0 | DTMG + V/Hsync method |
| 0 | 1 | DTMG method |
| 1 | * | V/Hsync method |

A signal for selecting a display rotation function is inputted to an RSCAN3 terminal shown in FIG. 2. The signal inputted to the RSCAN3 terminal provides a display rotation mode when the signal assumes L level and provides a usual output mode when the signal assumes H level.

An EIO1 terminal and an EIO2 terminal are input/output terminals of a start pulse. Input/output directions (including Hi-Z) are determined in response to signals inputted to the MST terminal, the LOC terminal, the GLR terminal, the SUD terminal and the RSCAN3 terminal.

An STH terminal constitutes an output terminal of the start pulse in case of the master drain driver 2a. The STH terminal of the master drain driver 2a is connected to the EIO1 terminals or the EIO2 terminals of the slave drain drivers (2b, 2c).

A reset signal is inputted to an RESETN terminal. The drain driver is reset when the signal inputted to the RESETN terminal assumes an L level, and upon detection of an H level of the signal inputted to the RESETN terminal, the drain driver starts a start-up sequence.

To respective terminals D2 [5:0], D1[5:0], D0 [5:0], display data of red, green and blue are inputted from the graphic processor unit (GPU) 8. Here, D2[5:0] indicates display data of red, D1[5:0] indicates display data of green, and D0[5:0] indicates display data of blue.

Start signals of the gate driver 3 are outputted from the respective terminals DIO1_L, DIO1_R, DIO2_L, DIO2_R shown in FIG. 2. In case of the master drain driver 2a, the start signal is outputted from one of these terminals, and the remaining terminals assume Hi-Z. In case of the slave drain drivers (2b, 2c), all terminals always assume Hi-Z.

A data shift clock of the gate driver 3 is outputted from respective terminals CL3_L, CL3_R. In case of the master drain driver 2a, the data shift clock is outputted from one of these terminals, and the remaining terminals assume Hi-Z. In case of the slave drain drivers (2b, 2c), all terminals always assume Hi-Z.

From respective terminals, GSHL_L, GSHL_R, signals for selecting the shift direction of the gate driver 3 are outputted. In case of the master drain driver 2a, the signal for selecting the shift direction of the gate driver 3 is outputted from one of these terminals, and the remaining terminals assume Hi-Z. In case of the slave drain drivers (2b, 2c), all terminals always assume Hi-Z.

In case of the master drain driver 2a, a signal for selecting either one of left and right sides of the master drain driver 2a from which a gate control signal is outputted is inputted to a GLR terminal. Further, irrelevant to the master and slave drain drivers (2a to 2c), in response to signals inputted to the MST terminal, the LOC terminal, the GLR terminal and the RSCAN3 terminal, the shift directions of the gate driver 3 and the drain drivers (2a to 2c) are selected.

A signal indicative of the arrangement position of the drain drivers (2a to 2c) with respect to the liquid crystal display panel is inputted to an SUD terminal. When the signal inputted to the SUD terminal assumes an L level, the drain drivers (2a to 2c) are arranged above the liquid crystal display panel, while when the signal inputted to the SUD terminal assumes an H level, the drain drivers (2a to 2c) are arranged below the liquid crystal display panel.

Signals for selecting the resolution of the liquid crystal display panel are inputted to respective terminals PSIZE1, PSIZE0. In this embodiment, the liquid crystal display panel exhibits the resolution shown in the following table 3 in response to the signals inputted to the terminals PSIZE1, PSIZE0.

TABLE 3

| | | | | liquid crystal | |
|---|---|---|---|---|---|
| PSIZE1 | PSIZE0 | MST | resolution | output | remarks |
| 0 | 0 | 0 | 240 × 400RGB | Y1~Y480 | |
| | | 1 | | Y1~Y180, | Y181~Y300 |
| | | | | Y301~Y480 | generate Hi-Z |
| | | | | | output |
| 0 | 1 | * | 320 × 240RGB | | |
| 1 | 0 | * | 240 × 320RGB | Y1~Y480 | |
| 1 | 0 | * | 240 × 480RGB | Y1~Y480 | |

An SCL terminal shown in FIG. 2 is a serial clock terminal of I²C bus interface, and an SDA terminal shown in FIG. 2 is a serial-address/data terminal of I²C bus interface. An A [2:0] terminal shown in FIG. 2 is a slave address terminal of I²C bus interface.

A signal for selecting whether data is to be read from the EEPROM25 or not at the time of starting a start-up sequence is inputted to a ROME terminal. When the signal inputted to the ROME terminal assumes an H level, data is read from the EEPROM25 at the time of starting the start-up sequence.

Further, when the signal inputted to the ROME terminal assumes an L level, data is not read from the EEPROM25 at the time of starting the start-up sequence. Here, the internal register 41 uses the default value in accordance with the PSIZE [1:0] of the liquid crystal display panel.

A signal indicative of completion of reading of the EEPROM25 is outputted from a CKSUMOUT terminal. This terminal is connected with a CKSUMIN terminal of the drain driver of a next stage in cascade connection. Further, a CKSUMOUT terminal of the drain driver 2c of a final stage is connected to the CKSUMIN terminal of the master drain driver 2a.

Due to such a connection, the master drain driver 2a can recognize that all drain drivers (2a to 2c) complete the reading of data from the EEPROM25 and can recognize timing at which a display of the liquid crystal display panel is shifted to a usual display.

Here, when a signal inputted to a CRCOFF terminal is effective, check sums of the data acquired in the register 41 are calculated using a CRC-8. When the check sums match each other, the above-mentioned operation is performed, while when the check sums do not match each other, rereading of the EEPROM25 is started.

A signal for making the check sum calculation performed using the CRC-8 invalid with respect to the data read from the EEPROM25 and stored in the register 41 is inputted to the CRCOFF terminal. When the signal inputted to the CRCOFF terminal assumes an L level, the check sums performed using the CRC-8 become effective, while when the signal inputted to the CRCOFF terminal assumes an H level, the check sums performed using the CRC-8 become invalid.

A signal indicative of timing at which the drain driver of a next stage starts reading of data from the EEPROM25 is inputted to the CKSUMIN terminal. The CKSUMIN terminal is connected to the CKSUMOUT terminal of the drain driver of a preceding stage.

Respective terminals TEST1, TEST2 are input terminals for test mode signals, and a TIO [7:0] terminal is an input/output terminal for a test mode signal.

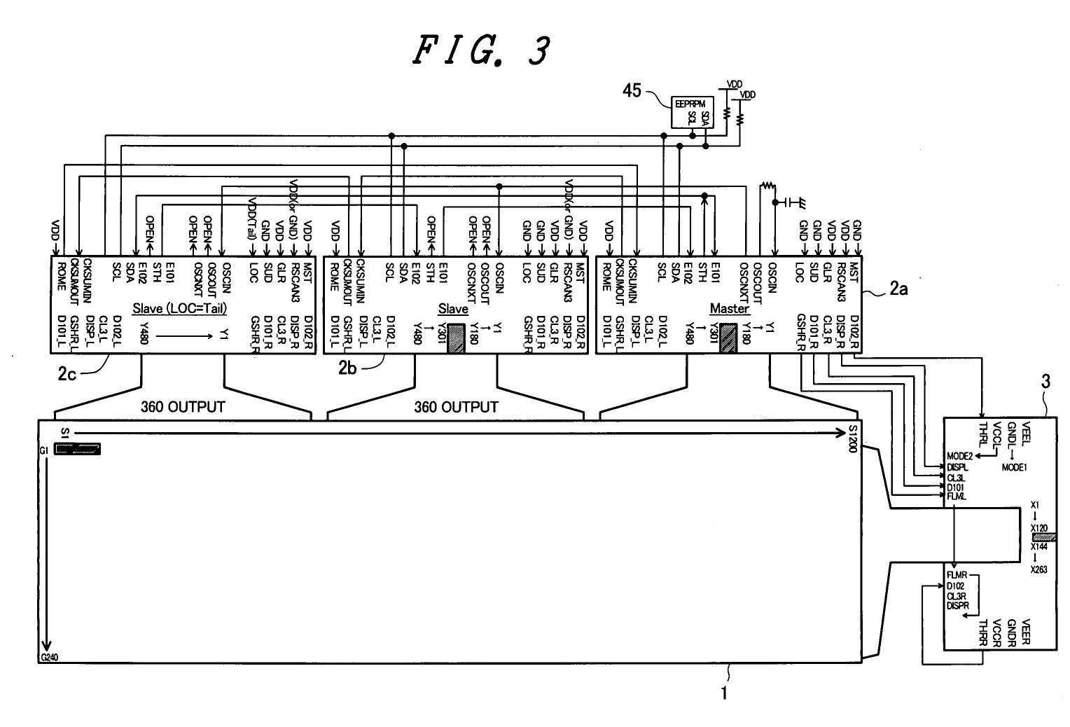

FIG. 3 to FIG. 6 are views showing arrangement examples of the drain drivers of this embodiment.

In the arrangement example shown in FIG. 3, the master drain driver 2a and the slave drain drivers (2b, 2c) are arranged above the liquid crystal display panel 1. Accordingly, a voltage of L (GND) level is inputted to the SUD terminal. Further, since a gate control signal is outputted from a left side of the master drain driver 2a, a voltage of H (VDD) level is inputted to the GLR terminal. Further, a voltage of H level is inputted to the RSCAN3 terminal.

Further, the direction indicated by an arrow shown in FIG. 3 indicates the usual shift direction, wherein the shift direction of the respective drain drivers (2a to 2c) is aligned with the directions from the video line (Y480) to the video line (Y1).

Accordingly, a start pulse is transferred in the direction from the EIO2 terminal to the EIO1 terminal and hence, the STH terminal of the master drain driver 2a is connected to the EIO1 terminal of the master drain driver 2a and, at the same time, is connected to the EIO2 terminal of the slave drain driver 2c.

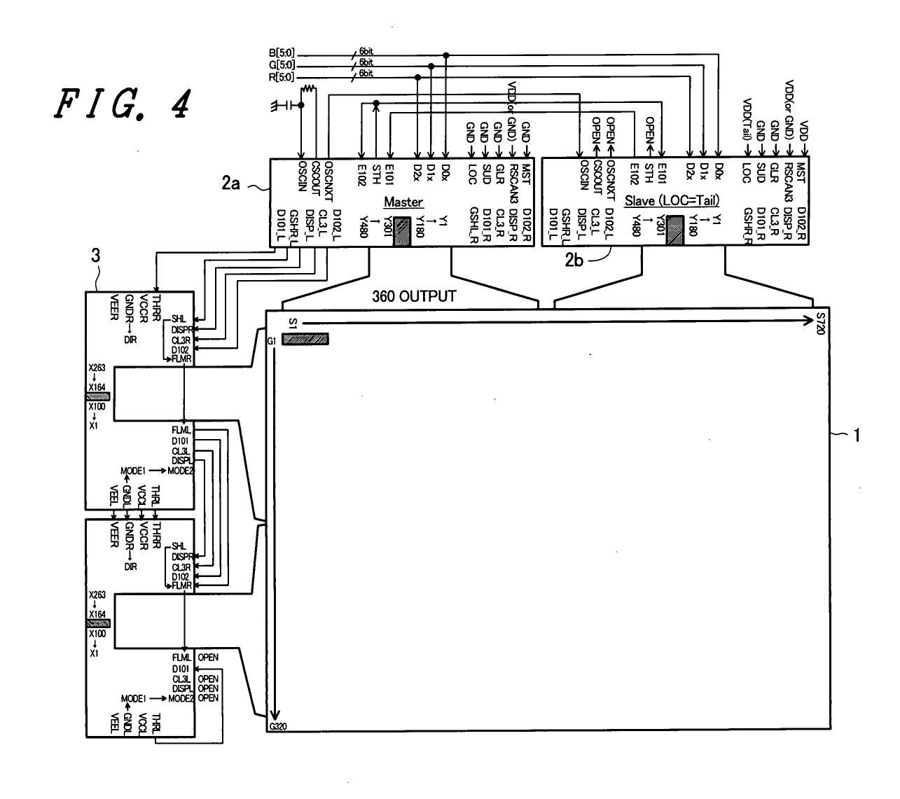

Also in the arrangement example shown in FIG. 4, the master drain driver 2a and the slave drain drivers (2b, 2c) are arranged above the liquid crystal display panel 1. Accordingly, a voltage of L level is inputted to the SUD terminal. Further, since a gate control signal is outputted from a right side of the master drain driver 2a, a voltage of L level is inputted to the GLR terminal. Further, a voltage of H level is inputted to the RSCAN3 terminal.

Further, the direction indicated by an arrow shown in FIG. 4 indicates the usual shift direction, wherein the shift direction of the respective drain drivers (2a to 2c) is aligned with the directions from the video line (Y480) to the video line (Y1).

Accordingly, a start pulse is transferred in the direction from the EIO2 terminal to the EIO1 terminal and hence, the STH terminal of the master drain driver 2a is connected to the EIO2 terminal of the master drain driver 2a and, at the same time, is connected to the EIO1 terminal of the slave drain driver 2b.

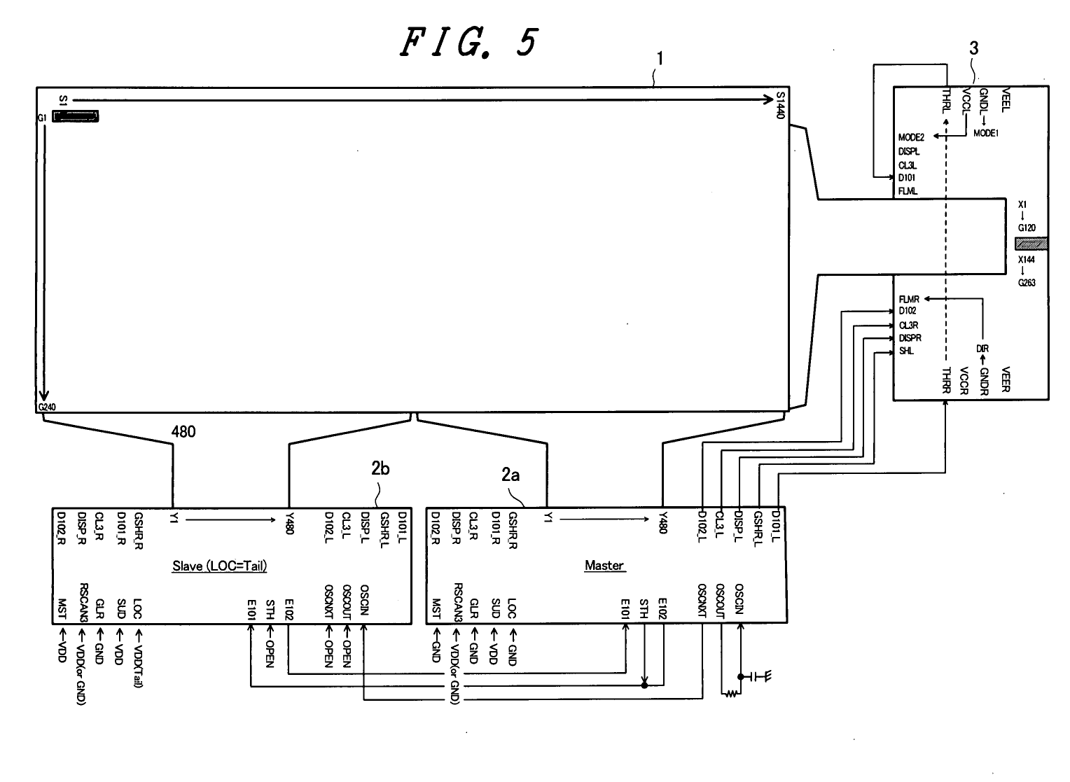

In the arrangement example shown in FIG. 5, the master drain driver 2a and the slave drain driver 2b are arranged below the liquid crystal display panel 1. Accordingly, a voltage of H (VDD) level is inputted to the SUD terminal. Further, since a gate control signal is outputted from a right side of the master drain driver 2a, a voltage of L (GND) level is inputted to the GLR terminal. Further, a voltage of H level is inputted to the RSCAN3 terminal.

Further, the direction indicated by an arrow shown in FIG. 5 indicates the usual shift direction, wherein the shift direction of the respective drain drivers (2a to 2c) is aligned with the direction from the video line (Y1) to the video line (Y480).

Accordingly, a start pulse is transferred in the direction from the EIO1 terminal to the EIO2 terminal and hence, the STH terminal of the master drain driver 2a is connected to the EIO2 terminal of the master drain driver 2a and, at the same time, is connected to the EIO1 terminal of the slave drain driver 2b.

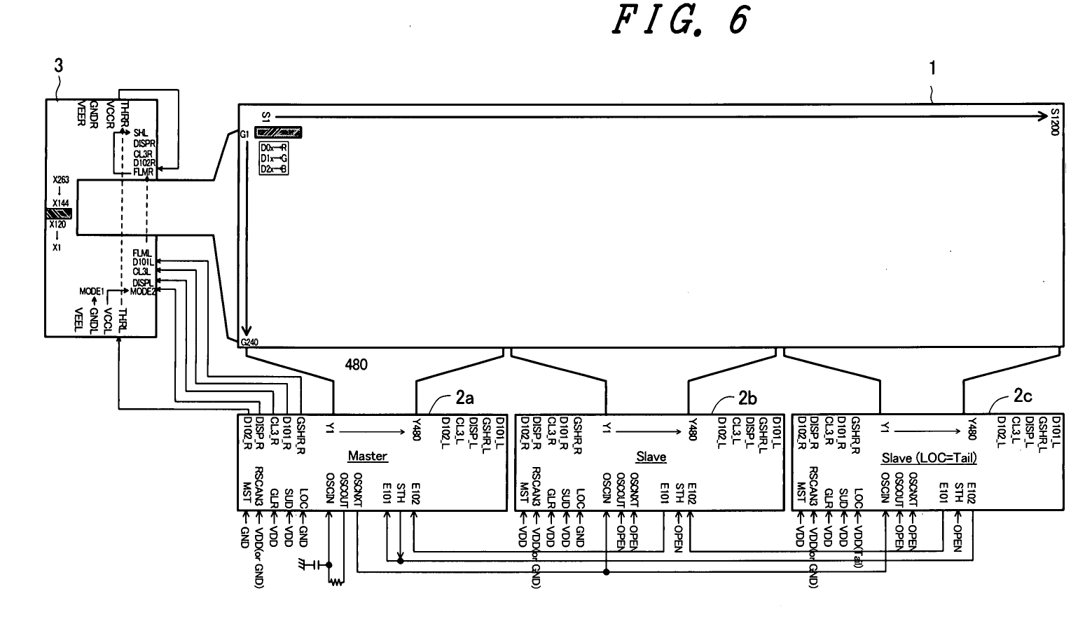

Also in the arrangement example shown in FIG. 6, the master drain driver 2a and the slave drain drivers (2b, 2c) are arranged below the liquid crystal display panel 1. Accordingly, a voltage of H (VDD) level is inputted to the SUD terminal. Further, since a gate control signal is outputted from a left side of the master drain driver 2a, a voltage of H level is inputted to the GLR terminal. Further, a voltage of H level is inputted to the RSCAN3 terminal.

Further, the direction indicated by an arrow shown in FIG. 6 indicates the usual shift direction, wherein the shift direction of the respective drain drivers (2a to 2c) is aligned with the directions from the video line (Y1) to the video line (Y480).

Accordingly, a start pulse is transferred in the direction from the EIO1 terminal to the EIO2 terminal and hence, the STH terminal of the master drain driver 2a is connected to the EIO1 terminal of the master drain driver 2a and, at the same time, is connected to the EIO2 terminal of the slave drain driver 2c.

As has been explained heretofore, according to the above-mentioned embodiment, by incorporating the display control circuit 40 in the drain drivers (2a to 2c), the number of parts can be reduced and hence, the reduction of cost can be achieved.

Here, the above-mentioned explanation has been made with respect to the embodiment in which the present invention is applied to the liquid crystal display device. However, it is needless to say that the present invention is not limited to the embodiment and the present invention is applicable to a display device in general which includes sub pixels such as an organic EL display device, for example.

Although the invention made by inventors of the present invention is specifically explained based on the embodiment, it is needless to say that the present invention is not limited to the embodiment and various modifications are conceivable without departing from the gist of the present invention.

What is claimed is:

1. A display device comprising:
a display panel having a plurality of pixels and a plurality of video lines which inputs a video voltage to the plurality of pixels; and
a plurality of video line drive circuits which supplies a video voltage to the plurality of video lines, wherein
each video line drive circuit includes a display control circuit,
each video line drive circuit is connected to a bus, one video line drive circuit out of the plurality of video line drive circuits is operable as a master video line drive circuit, and
the video line drive circuits other than the master video line drive circuit out of the plurality of video line drive circuits are operable as slave video line drive circuits.

2. A display device according to claim 1, wherein each video line drive circuit is operable as the master video line drive circuit when a voltage level of a voltage inputted to a master/slave changeover terminal (MST) assumes a first voltage level, and is operable as the slave video line drive circuit when a voltage level of a voltage inputted to the master/slave changeover terminal (MST) assumes a second voltage level which differs from the first voltage level.

3. A display device according to claim 1, wherein the master video line drive circuit includes a clock oscillation circuit, and a clock from the clock oscillation circuit of the master video line drive circuit is inputted to the slave video line drive circuits.

4. A display device according to claim 1, wherein the plurality of video line drive circuits is arranged in series on a first side of the display panel, and a leading video line drive circuit out of the plurality of video line drive circuits which is arranged in series constitutes the master video line drive circuit and the next and succeeding video line drive circuits constitute the slave video line drive circuits.

5. A display device according to claim 1, wherein the display panel includes a plurality of scanning lines which inputs a scanning voltage to the plurality of pixels, the display panel includes at least one scanning line drive circuit which supplies the scanning voltage to the plurality of scanning lines, each video line drive circuit includes a plurality of scanning control terminals which outputs a scanning line drive circuit control signal for controlling at least one scanning line drive circuit, and the master video line drive circuit outputs the scanning line drive circuit control signal to at least one scanning line drive circuit from the plurality of scanning control terminals.

6. A display device according to claim 5, wherein the plurality of scanning control terminals is arranged on both left and right sides of each video line drive circuit in the longitudinal direction, and each video line drive circuit outputs the scanning line drive circuit control signal to at least one scanning line drive circuit from the plurality of scanning control terminals arranged on the left side when a voltage level of a voltage inputted to a scanning control terminal selection terminal (GLR) assumes a first voltage level, and
outputs the scanning line drive circuit control signal to at least one scanning line drive circuit from the plurality of scanning control terminals arranged on the right side when the voltage level of the voltage inputted to the scanning control terminal selection terminal (GLR) assumes a second voltage level which differs from the first voltage level.

7. A display device according to claim 6, wherein at least one scanning line drive circuit is arranged on a second side of the display panel arranged close to a first side of the display panel.

8. A display device according to claim 1, wherein the display control circuit of each video line drive circuit includes a register for holding a predetermined value of the display control circuit, and the predetermined value of the display control circuit is writable to the register from an external memory when the display device is started.

9. A display device according to claim 8, wherein, at the time of writing the predetermined value of the display control circuit from the external memory to the register at the time of starting the display device, the display device accesses to the external memory from the master video line drive circuit to the final slave video line drive circuits in order, and writes the predetermined value in the register.
